(19) United States
(12) Patent Application Publication
(10) Pub. No.: US 2026/0292635 A1
(43) Pub. Date: Sep. 24, 2026

(54) LINK LEVEL FEATURE HANDLING FOR SEAMLESS ROAMING

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Frisco, TX (US); Vishnu Vardhan Ratnam, Frisco, TX (US); Yue Qi, Plano, TX (US); Bilal Sadiq, Plano, TX (US)

(21) Appl. No.: 19/466,170

(22) Filed: Jan. 30, 2026

Related U.S. Application Data
(60) Provisional application No. 63/757,164, filed on Feb. 11, 2025.
(60) Provisional application No. 63/757,180, filed on Feb. 11, 2025.
(60) Provisional application No. 63/757,191, filed on Feb. 11, 2025.
(60) Provisional application No. 63/914,554, filed on Nov. 10, 2025.

(51) Int. Cl. H04W 36/18; H04W 36/00; H04W 84/12

(52) U.S. Cl. CPC H04W 36/18; H04W 36/0011; H04W 84/12

(57) ABSTRACT

Methods and apparatuses for link level feature handling procedures for seamless roaming. A method performed by a current access point (AP) multi-link device (MLD) comprises receiving, from a non-AP MLD via a preparation request frame, information indicating a link to be setup with a target AP MLD during a roam procedure for the non-AP MLD to roam from the current AP MLD to the target AP MLD. The method includes receiving, from the target AP MLD via a response frame, information indicating that the link has been setup and that an AP of the target AP MLD that was unavailable during a periodic unavailability operation (PUO) mode of operation can become available; and transmitting, to the non-AP MLD via a preparation response frame, information indicating that the link has been setup and that the AP of the target AP MLD can become available for frame exchanges with the non-AP MLD.

### CROSS-REFERENCE TO RELATED APPLICATION(S) AND CLAIM OF PRIORITY

This application claims priority under 35 U.S.C. § 119 (e) to U.S. Provisional Patent Application No. 63/757,164, filed on Feb. 11, 2025, U.S. Provisional Patent Application No. 63/757,180, filed on Feb. 11, 2025, U.S. Provisional Patent Application No. 63/757,191, filed on Feb. 11, 2025, and U.S. Provisional Patent Application No. 63/914,554, filed on Nov. 10, 2025, each of which are hereby incorporated by reference in their entirety.

### TECHNICAL FIELD

This disclosure relates generally to wireless communication, and more specifically to link level feature handling for seamless roaming.

### BACKGROUND

Wireless Local Area Network (WLAN) technology allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

Embodiments of the present disclosure provide methods and apparatuses for link level feature handling procedures for seamless roaming.

In one embodiment, a method performed by a current access point (AP) multi-link device (MLD) comprises receiving, from a non-AP MLD via a preparation request frame, information indicating a link to be setup with a target AP MLD during a roam procedure for the non-AP MLD to roam from the current AP MLD to the target AP MLD. The method includes receiving, from the target AP MLD via a response frame, information indicating that the link has been setup and that an AP of the target AP MLD that was unavailable during a periodic unavailability operation (PUO) mode of operation can become available; and transmitting, to the non-AP MLD via a preparation response frame, information indicating that the link has been setup and that the AP of the target AP MLD can become available for frame exchanges with the non-AP MLD.

In another embodiment, a method performed by a non-AP MLD comprises transmitting, to a current AP MLD via a preparation request frame, information indicating a link to be setup with a target AP MLD during a roam procedure for the non-AP MLD to roam from the current AP MLD to the target AP MLD; and receiving, from the current AP MLD via a preparation response frame, information indicating that the link has been setup and that an AP of the target AP MLD that was unavailable during a periodic unavailability operation (PUO) mode of operation can become available for frame exchanges with the non-AP MLD.

In yet another embodiment, an electronic device comprises at least one processor including processing circuitry; and memory storing instructions, where the instructions, when executed by the at least one processor individually or collectively, cause the electronic device to: receive, from a non-AP MLD via a preparation request frame, information indicating a link to be setup with a target AP MLD during a roam procedure for the non-AP MLD to roam from the current AP MLD to the target AP MLD; receive, from the target AP MLD via a response frame, information indicating that the link has been setup and that an AP of the target AP MLD that was unavailable during a periodic unavailability operation (PUO) mode of operation can become available; and transmit, to the non-AP MLD via a preparation response frame, information indicating that the link has been setup and that the AP of the target AP MLD can become available for frame exchanges with the non-AP MLD.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example access point (AP) according to embodiments of the present disclosure;

FIG. 2B illustrates an example station (STA) according to embodiments of the present disclosure;

FIG. 3 illustrates an example illustrating a periodic unavailability setup according to embodiments of the present disclosure;

FIG. 4 illustrates an example setup of a periodic unavailability according to embodiments of the present disclosure;

FIG. 5 illustrates an example of periodic unavailability being unavailable after roam according to embodiments of the present disclosure;

FIG. 6 illustrates an example of periodic unavailability becoming available after roam according to embodiments of the present disclosure;

FIG. 7 illustrates an example of a broadcast/restricted target wake time (B/R-TWT) according to embodiments of the present disclosure;

FIG. 8 illustrates an example of providing frequency resource unavailability information at the time of setting up peer-to-peer (P2P) TWT according to embodiments of the present disclosure;

FIG. 9 illustrates an example of providing a frequency resource based peer-to-peer (P2P) unavailability indication according to embodiments of the present disclosure;

FIG. 10 illustrates an example of providing frequency resource unavailability information after setting up P2P TWT according to embodiments of the present disclosure;

FIG. 11 illustrates an example call flow for transfer of periodic unavailability operation (PUO) information according to embodiments of the present disclosure;

FIG. 12 illustrates an example call flow for transfer of PUO information during roaming according to embodiments of the present disclosure;

FIG. 13 illustrates an example call flow for PUO session setup at the target access point (AP) via the current AP according to embodiments of the present disclosure;

FIG. 14 illustrates an example call flow showing target AP MLD AP PUO handling according to embodiments of the present disclosure;

FIG. 15 illustrates an example call flow showing advertisement of AP PUO constraints according to embodiments of the present disclosure;

FIG. 16 illustrates an example schedule from the current AP MLD setup at the target AP MLD according to embodiments of the present disclosure;

FIG. 17 illustrates an example call flow showing information about similar broadcast TWT existence at the target AP according to embodiments of the present disclosure;

FIG. 18 illustrates an example request type field format according to embodiments of the present disclosure;

FIG. 19 illustrates an example TWT parameter set field format according to embodiments of the present disclosure; and

FIG. 20 illustrates an example method performed by a current AP MLD in a wireless communication system according to embodiments of the present disclosure.

### DETAILED DESCRIPTION

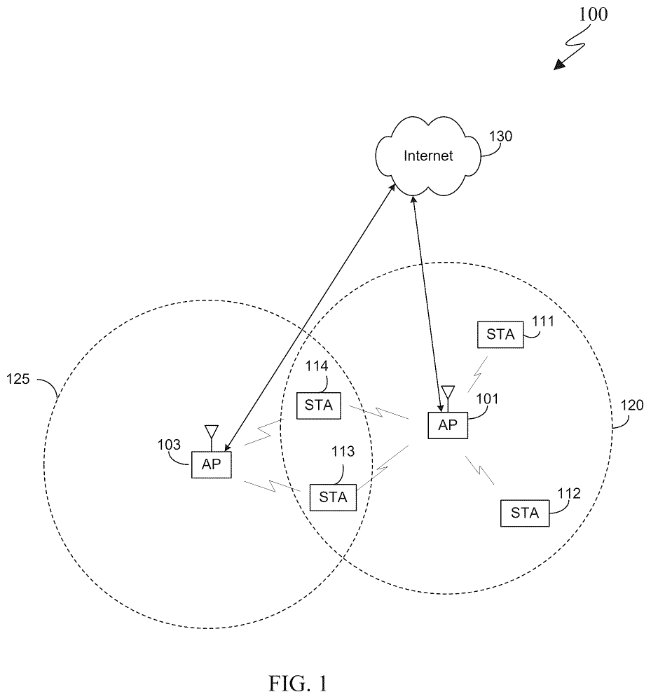

FIGS. 1 through 20, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE P802.11be/D7.0, 2024; [2] IEEE Std 802.11-2020; [3] IEEE P802.11bn/D1.0, 2025; [4] IEEE 802.11Rev me/D7.0, 2024.

Existing WLAN standards support multiple bands of operation, where an access point (AP) and a non-AP device may communicate with each other, called links. Thus, both the AP and non-AP device may be capable of communicating on different bands/links, which is referred to as mutli-link operation (MLO). Devices capable of such MLO are referred to as multi-link devices (MLDs).

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating link level feature handling procedures for seamless roaming in WLANs. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

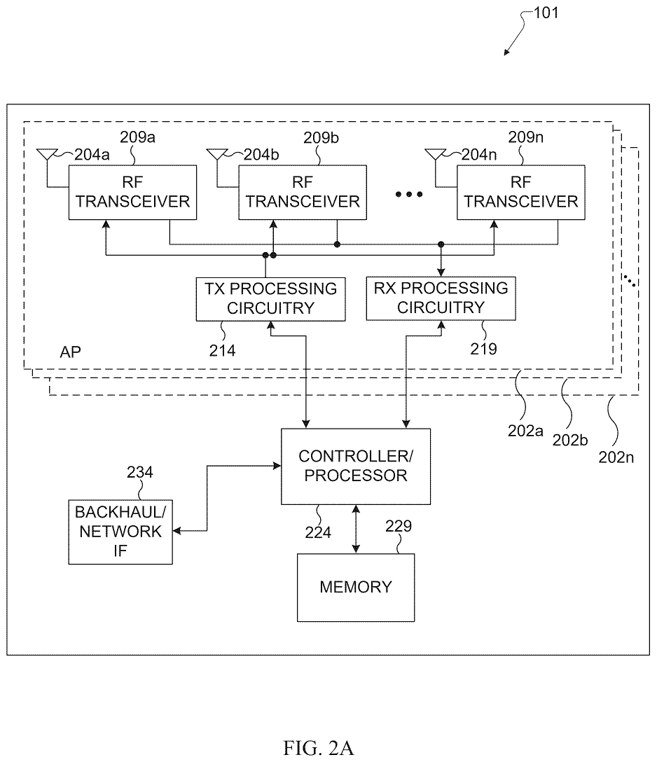

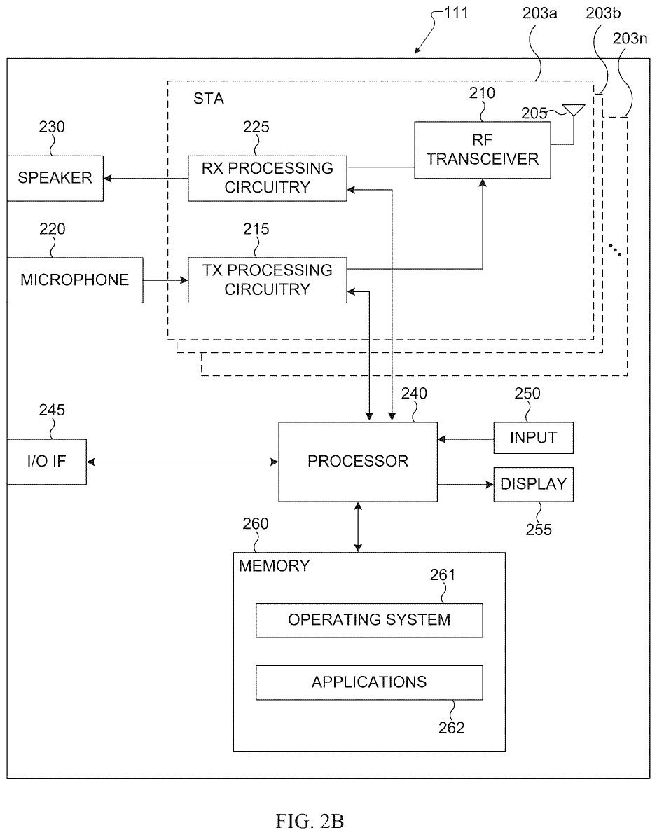

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHZ, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHZ, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support orthogonal frequency division multiple access (OFDMA) operations in which outgoing signals are assigned to different subsets of subcarriers for different recipients (e.g., different STAs 111-114). Any of a wide variety of other functions could be supported in the AP MLD 101 by the controller/processor 224 including DL data handling in seamless roaming in WLANs. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for facilitating link level feature handling procedures for seamless roaming in WLANs. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a processor 240, an input/output (I/O) interface (IF) 245, an input 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHZ, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHZ, or 6 GHz, the outgoing RF signals transmitted by each affiliated STA may be at a different frequency of RF.

The processor 240 can include one or more processors and execute the basic OS program 261 stored in the memory 260 in order to control the overall operation of the non-AP MLD 111. In one such operation, the processor 240 controls the reception of forward channel signals and the transmission of reverse channel signals by the RF transceiver 210, the RX processing circuitry 225, and the TX processing circuitry 215 in accordance with well-known principles. The processor 240 can also include processing circuitry configured to facilitate link level feature handling procedures for seamless roaming in WLANs. In some embodiments, the processor 240 includes at least one microprocessor or microcontroller.

The processor 240 is also capable of executing other processes and programs resident in the memory 260, such as operations for facilitating link level feature handling procedures for seamless roaming in WLANs. The processor 240 can move data into or out of the memory 260 as required by an executing process. In some embodiments, the processor 240 is configured to execute a plurality of applications 262, such as applications for facilitating link level feature handling procedures for seamless roaming in WLANs. The processor 240 can operate the plurality of applications 262 based on the OS program 261 or in response to a signal received from an AP. The processor 240 is also coupled to the I/O interface 245, which provides non-AP MLD 111 with the ability to connect to other devices such as laptop computers and handheld computers. The I/O interface 245 is the communication path between these accessories and the processor 240.

The processor 240 is also coupled to the input 250 and the display 255. The operator of the non-AP MLD 111 can use the input 250 to enter data into the non-AP MLD 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

The goal of seamless roaming is to provide mechanisms for a non-AP MLD to transition from the current AP MLD to the target AP MLD such that the time during which the connection is lost is minimal. The seamless roaming procedure can enable a non-AP MLD to remain in state 4 while transitioning from the current AP MLD to the target AP MLD.

The roaming procedure can comprise multiple stages. Two of the stages are a preparation stage and roam execution/transition stage. During the preparation stage, the non-AP MLD can setup links with the target AP MLD and perform context transfer. Following this stage, the non-AP MLD can perform a roam execution/transition procedure by sending a request frame to transition from the current AP MLD to the target AP MLD. The current AP MLD can process the request frame and send a response frame to the non-AP MLD after the transfer of context is complete.

These procedures can enable the non-AP MLD to seamlessly roam from the current AP MLD to the target AP MLD.

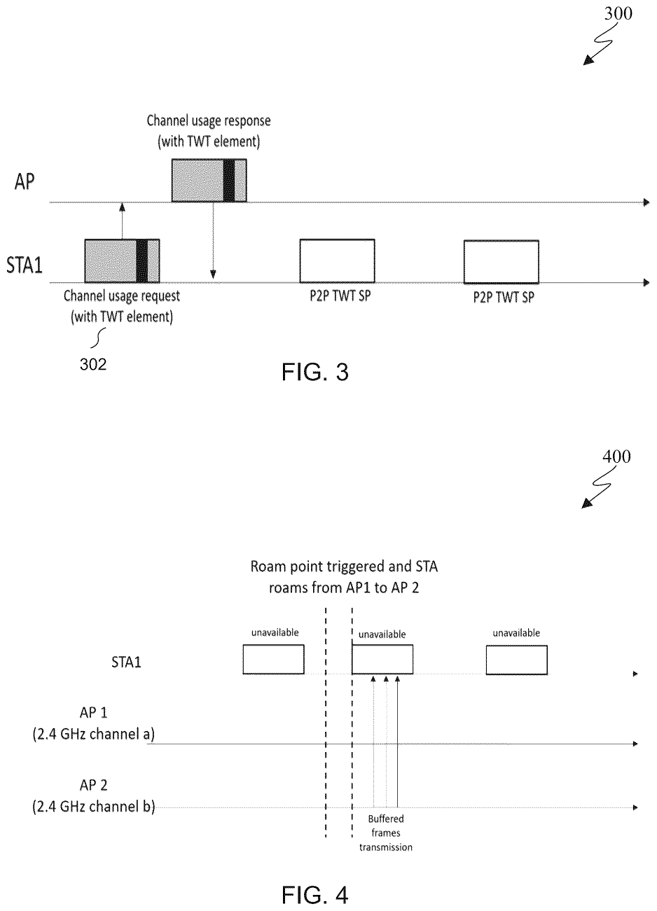

FIG. 3 illustrates an example illustrating a periodic unavailability setup 300 according to embodiments of the present disclosure. The embodiment of the example periodic unavailability setup 300 shown in FIG. 3 is for illustration only. Other embodiments of the example periodic unavailability setup could be used without departing from the scope of this disclosure.

Embodiments of the present disclosure recognize scenarios where PUO can enable a non-AP STA to inform its associated AP STA about the STA's unavailability during periodic service periods. To indicate its unavailability, the non-AP STA can setup a P2P TWT with the AP. As per [4], to indicate unavailability, a non-AP STA can transmit a channel usage request frame with a usage mode field of the channel usage element set to 3 and without a channel entry field to inform the AP about its unavailability during the P2P TWT agreement. An example can be as shown in FIG. 3.

Embodiments of the present disclosure recognize that the TWT feature was introduced in 802.11ax to provide power-saving benefits to the STA when the STA's traffic patterns are predictable. The TWT feature enables an AP and a STA to agree to specific time durations referred to as TWT service periods (SPs) during which DL (downlink) and UL (uplink) frames can be exchanged between them. The STA can doze outside of these service periods. The feature also enables an efficient management of channel contention by scheduling STAs to operate on different TWT SPs. The amendment defined two modes of TWT operation-individual TWT and broadcast TWT. The individual TWT agreement is between an AP and a STA. Broadcast TWT schedule allows an AP to establish a TWT schedule with multiple STAs. Restricted TWT is built on top of broadcast TWT. It is designed to provide a predictable latency performance for the STA's low latency traffic.

Embodiments of the present disclosure recognize that dynamic power save (DPS) mode allows a STA to operation in lower capability mode and to transition to a higher capability mode after it receives an initial control frame (ICF) from its assisting STA. As per [3], a DPS assisting STA shall solicit the transition of the peer DPS STA to a higher capability mode by sending an ICF which is transmitted in non-HT (duplicate) PPDU using a rate of 6, 12 or 24 Mbps.

Embodiments of the present disclosure recognize that when a non-AP MLD that has one or more non-AP STAs affiliated with it, the non-AP MLD is capable of associating with an AP MLD with one or more affiliated AP STAs and setup one or more links with the AP MLD. The AP MLD can be a part of a seamless mobility domain (SMD). The SMD can include multiple AP MLDs where the non-AP MLD can perform an SMD basic service set (BSS) transition procedure between the AP MLDs while maintaining association with the seamless mobility domain management entity (SMD-ME). The SMD BSS transition can be a mechanism for a non-AP MLD to transition from its current AP MLD to a target AP MLD without requiring reassociation. Thus, the SMD BSS transition procedure can minimize the time during which the connectivity between the non-AP MLD and the distribution system (DS) is lost. The non-AP MLD can remain in state 4 of association with the SMD-ME during the SMD BSS transition while preserving the context for data transmission. This can result in a seamless experience. The SMD-ME can provide SMD-level authentication and association, IEEE 802.1X authenticator functions and the Robust Security Network Association (RSNA) key management function for non-AP MLDs across all AP MLDs within the SMD. The SMD can have two data path models between the non-AP MLD and the DS. One data path model can be one where a single MAC SAP is used for the SMD. Another data path model can be one which has a separate MAC SAP per AP MLD of the SMD. At a time, only one of the two data paths can be used.

The non-AP MLD can perform an initial association with the SMD-ME through an AP MLD within the SMD. This association can establish an SMD-level security association across all AP MLDs in the SMD. The non-AP MLD can transition between AP MLDs within this SMD while maintaining its association and security association with the SMD-ME.

The non-AP MLD can use mechanisms such as active scanning (e.g., probing, multi-link probe request and response exchanges, etc.), the BSS transition management (BTM) framework, the neighbor report framework for discovery of the neighboring AP MLDs and the SMD BSS transition support by those AP MLDs.

Further an AP MLD can use the BTM framework to recommend one or more candidate target AP MLDs within the SMD. The current AP MLD can transmit an unsolicited BTM request containing the candidate target AP's information. The non-AP MLD can also request for information on one or more candidate target AP MLDs in the SMD. The non-AP MLD can transmit a BTM query frame to the current AP MLD and request for candidate target AP MLD's information. Thus, the non-AP MLD can discover the capabilities, feature support and constraints at the target AP MLD.

When the non-AP MLD uses SMD BSS transition to transition from an AP MLD (referred to as the current AP MLD without loss of generality) to another AP MLD within the same SMD (referred to as the target AP MLD), the non-AP MLD can perform an SMD BSS transition preparation procedure. The preparation procedure can be performed in advance before the transition occurs. The preparation procedure can be performed by transmitting a preparation request frame to the current AP MLD. Each preparation request can identify a target AP MLD that the non-AP MLD intends to prepare for a transition. Based on the preparation request, there can be a transfer of context related to the non-AP MLD from the current AP MLD to the target AP MLD. Context can be resources or parameters associated with one or more features setup at the target AP MLD. Examples of contexts can be block acknowledgement (BA) setup parameters, SCS, MSCS, EPCS, etc. that are setup at the current AP MLD. Further, the preparation can also allow the non-AP MLD to add one or more links (i.e., form links with APs) with the target AP MLD. The current AP MLD can transmit a preparation response frame that can inform the non-AP MLD about the status of the preparation, the links added and the contexts out of the requested contexts that have been successfully transmitted. Some contexts can be assumed to be transferred even if not explicitly requested by the non-AP MLD.

The target AP MLD can be kept prepared for a certain period of time. Within this period of time, the non-AP MLD can be required to perform an execution procedure to the target AP MLD. If performed outside this period of time, the preparation can be considered as expired resulting in the context and added links getting deleted. In this case, the execution can fail. This period can be referred to as a timeout period in this disclosure.

The execution procedure can either be performed via the current AP MLD or via the target AP MLD. When the execution procedure is performed via the current AP MLD, the non-AP MLD can transmit an execution request frame to the current AP MLD. The current AP MLD can transfer any context that is required to be transferred (e.g., sequence number (SN)) and that is not already transferred to the target AP MLD. The current AP MLD can transfer an execution response frame to the non-AP MLD. When the execution procedure is performed via the target AP MLD, the non-AP MLD can transmit the execution request frame to the target AP MLD. The target AP MLD can then perform the transfer of any context that is required to be transferred and that is not already transferred from the current AP MLD to the target AP MLD. The target AP MLD can transmit an execution response frame to the non-AP MLD.

One or more APs affiliated with the AP MLDs in the SMD can support a periodic unavailability operation (PUO) mode. The PUO mode can allow an AP to define service periods and to save power or use internal resources elsewhere by being unavailable to all associated STAs outside of these service periods. An AP that supports PUO mode can advertise the support by setting an AP PUO support field in a MAC capabilities information field of a capabilities element it transmits to 1. An AP that does not support PUO mode of operation can advertise the support by setting an AP PUO support field in a MAC capabilities information field of a capabilities element it transmits to 0.

To be unavailable outside of broadcast TWT SPs, an AP that support AP PUO mode can advertise a TWT element that carries one or more broadcast TWT parameters set fields with a broadcast TWT ID set to 0 (to indicate that the broadcast TWT schedule can apply to all the STAs) and a responder PM mode subfield set to 1. The NDP paging indicator/unavailability mode subfield can be set to 0 to indicate that the AP can be unavailable outside of these broadcast TWT SPs except within any other TWT SP that can be setup with the AP or that can be advertised by the AP. The NDP paging indicator/unavailable mode subfield can be set to 1 to indicate that the AP can be unavailable outside of these broadcast TWT SPs even if that time falls within any other TWT SP that can be setup with the AP or that can be advertised by the AP. The STA associated with the AP can then consider the AP to be unavailable outside of the broadcast TWT SPs.

An AP that intends to enable or disable the AP PUO mode can follow an enhanced BSS parameter critical update procedure to notify its associated assisting non-AP STA. If an AP intends to disable, enable or update one or more parameters for AP PUO mode, then a reporting AP can include a UHR parameters update element in the beacon, probe response and (re) association response frames that it transmits and can provide an indication of the enhanced critical update.

The non-AP STA affiliated with the non-AP MLD can support an operation with an AP PUO AP and thus can be an AP PUO assisting non-AP STA.

The non-AP STA affiliated with the non-AP MLD can have a support for PUO and can indicate to its associated AP that it can be unavailable during periodic service periods. If the AP supports PUO for its associated STAs, the AP can set a PUO support field of a MAC capabilities information field of a capabilities element that it transmits to 1. If the AP does not support PUO for its associated STAs, the field can be set to 0. Further, the non-AP STA that supports PUO can set a PUO support field in a MAC capabilities information field of a capabilities element that it transmits to 1. Otherwise, it can set it to 0.

To be unavailable during specific service periods, the non-AP STA can use a channel usage procedure to report its periodic unavailability through a peer-to-peer TWT setup. The non-AP STA can send a Channel Usage Request frame to its associated AP with a TWT element configured as a TWT request. In this case, if the non-AP STA receives a Channel Usage Response frame from the AP that includes a TWT element configured as a TWT response with the TWT Setup Command field indicating Accept TWT, then the non-AP STA has successfully completed the peer-to-peer TWT agreement with the AP for the TWT flow identifier indicated in the TWT element that is carried in the Channel Usage Response frame. Otherwise, that peer-to-peer TWT agreement has not been established. The TWT flow identifier, together with the MAC addresses of the requesting STA and the responding AP, identifies the peer-to-peer TWT agreement. To indicate its unavailability, a non-AP STA can transmit a Channel Usage Request frame with the Usage Mode field of the Channel Usage element set to 3 and without a Channel Entry field to inform the AP about its unavailability during the peer-to-peer TWT agreement, also referred to as unavailability notification. Otherwise, the non-AP STA can set the Usage Mode field to 0, 1 or 2. A non-AP STA can teardown a peer-to-peer TWT agreement by sending a TWT Teardown frame with the Negotiation Type subfield set to 0 and the TWT Flow Identifier field set to the value of the corresponding TWT flow identifier.

Once setup, the AP cannot schedule for transmission any PPDU containing frames addressed to the non-AP STA that overlaps with the non-AP STA's unavailability service period and if the AP still transmits a PPDU that overlaps with the non-AP STA's unavailability service period, the non-AP STA cannot be expected to receive the PPDUs.

### A. PERIODIC UNAVAILABILITY HANDLING UNDER SEAMLESS ROAMING

### STA Side Periodic Unavailability Handling:

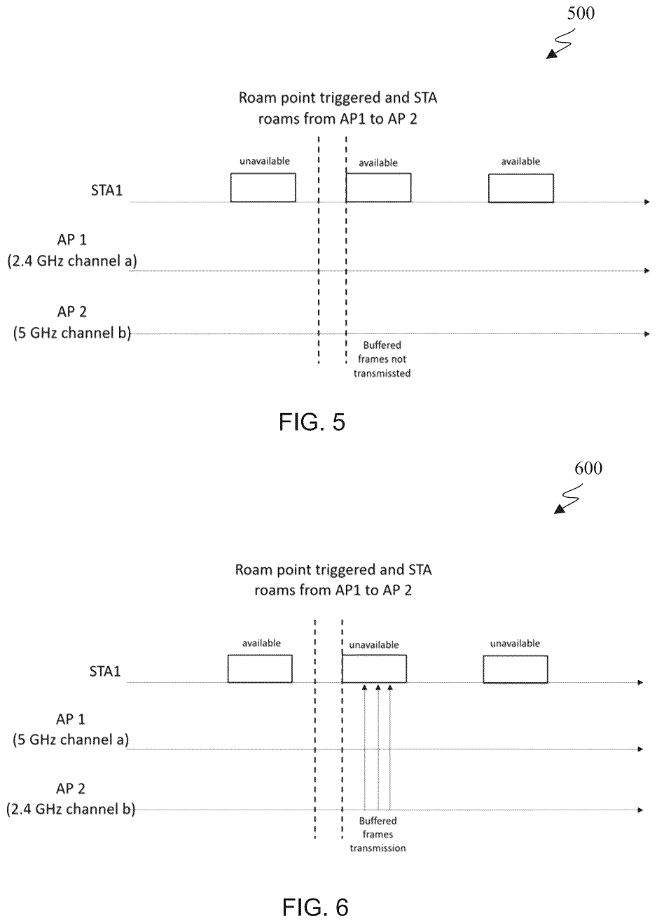

FIG. 4 illustrates an example setup of a periodic unavailability 400 according to embodiments of the present disclosure. The embodiment of the example setup of a periodic unavailability 400 shown in FIG. 5 is for illustration only. Other embodiments of the example setup of a periodic unavailability could be used without departing from the scope of this disclosure.

Consider a non-AP STA that has setup a periodic unavailability with an AP as shown in FIG. 4. At some point in time, the non-AP STA can roam to another AP (as the non-AP MLD transitions from the current AP MLD to the target AP MLD its corresponding STAs can transition to the respective AP STAs of the target AP MLD). However, right after the transition the non-AP STA can be unavailable. It is important for the AP to be aware of this. Otherwise, if it does not get any response from the non-AP STA, it can disassociate the non-AP STA.

FIG. 5 illustrates an example of periodic unavailability being unavailable after roam 500 according to embodiments of the present disclosure. The embodiment of the example of periodic unavailability being unavailable after roam 500 shown in FIG. 5 is for illustration only. Other embodiments of the example of periodic unavailability being unavailable after roam could be used without departing from the scope of this disclosure.

In another example as illustrated in FIG. 5, the non-AP STA can roam from an AP on one band to an AP on another band. In this case, the previous periodic unavailability indicated by the non-AP STA may no longer be valid. It is important for the AP at the target AP MLD to be aware of this. Otherwise, it can refrain from sending any buffered frames to the non-AP STA in that period of time resulting in an inefficient transmission. For example, the STA has Bluetooth operation on 2.4 GHz and after roam, it transitions to an AP that is operating on 5 GHz. As a result, the previously indicated unavailability does not hold true.

FIG. 6 illustrates an example of periodic unavailability becoming available after roam 600 according to embodiments of the present disclosure. The embodiment of the example of periodic unavailability becoming available after roam 600 shown in FIG. 6 is for illustration only. Other embodiments of the example of periodic unavailability becoming available after roam could be used without departing from the scope of this disclosure.

In another example as shown in FIG. 6, the STA roams from AP1 to AP2 and it starts to face a periodic unavailability after roam. For example, the STA has BT operation on 2.4 GHz and has to roam from an AP on 5 GHz to an AP on 2.4 GHz. The STA may not have indicated its unavailability on 5 GHz to AP1 as it was available on AP1's channel.

### AP Side Periodic Unavailability Handling:

An AP affiliated with an AP MLD can also have a periodic unavailability operation. When a non-AP MLD transitions from the current AP MLD to the target AP MLD, the APs affiliated with the target AP MLD can be unavailable due to PUO. This can cause issues to the non-AP MLD. For instance, the non-AP MLD can encounter unexpected delays in initial frame exchanges based on which the non-AP MLD can incorrectly conclude that the target AP MLD is out of range, unreachable or the links are already broken and the non-AP MLD can end up performing a legacy association with another AP MLD in the SMD. Thus, the non-AP MLD can lose the benefits of a seamless transition. A procedure to handle this scenario is also needed.

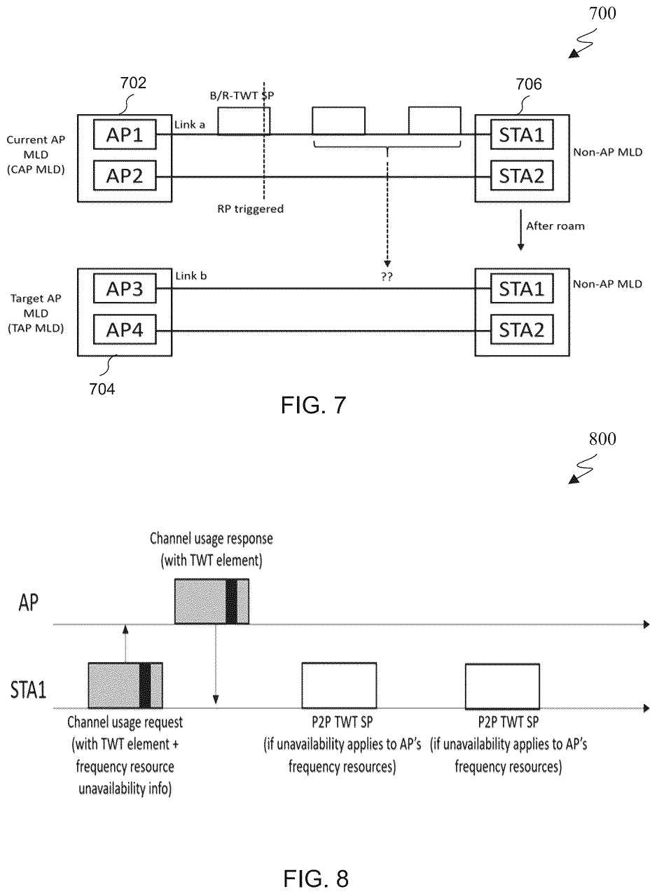

FIG. 7 illustrates an example of a broadcast/restricted target wake time (B/R-TWT) 700 according to embodiments of the present disclosure. The embodiment of the example of a B/R-TWT 700 shown in FIG. 7 is for illustration only. Other embodiments of the example of a B/R-TWT could be used without departing from the scope of this disclosure.

As shown in FIG. 7, a non-AP MLD that roams from its current AP MLD (702) to a target AP MLD (704), can be a member of a broadcast/restricted TWT schedule at the current AP MLD. This broadcast/restricted TWT schedule can be suitable for the traffic requirements of the non-AP MLD. Consequently, after roaming, the non-AP MLD may want to have the same or similar or a suitable broadcast/restricted TWT schedule at the target AP MLD. Setting up the schedule after roaming can result in delays to the already active traffic stream of the non-AP MLD. Consequently, it is important for the non-AP MLD to have a broadcast/restricted TWT schedule setup at the target AP MLD prior to the completion of the roam execution phase. A procedure is needed to handle the broadcast/restricted TWT schedule of the non-AP MLD after roaming.

In the above example, the non-AP MLD (706) transitions from the current AP to the target AP after the roam point is triggered. The STA1 affiliated with the non-AP MLD has a B/R-TWT schedule setup on a link a of the current AP. After roaming, the non-AP MLD may need to setup a B/R-TWT schedule on link b or find one (if already setup at the target AP) and request to become a member of the schedule. The setup procedure can take some time during which the traffic of the non-AP MLD cannot benefit from a B/R-TWT schedule at the target AP.

When a STA undergoes roaming, the STA may have enabled a DPS mode. As a result, it may need an ICF to transition to a HC mode of operation. The target AP may not be aware of this.

When the target AP enables DPS prior to a STA roaming, it is important that the STA knows that the target AP has enabled DPS mode. Otherwise, the STA may not know how to initiate transmission (with an ICF) in accordance with the DPS requirements with the target AP.

When the current AP enables DPS after the STA has completed the roam execution procedure, the current AP needs to inform the STA. In case the STA intends to fetch buffered data frames from the current AP after completion of the roam execution procedure, the STA may need to know the current AP's DPS enabled state and may not initiate a transmission with an ICF.

In this disclosure, a number of solutions are presented for handling PUO session during a roaming transition, including:
1. Indication of frequency resources on which the STA can be unavailable
2. Transfer of periodic unavailability session
3. Transfer of the next unavailability SP information
4. Cancellation of PUO at the current AP/target AP
5. Setup a PUO session at the target AP via the current AP
6. Capability indication
7. Target AP MLD's AP becomes available
8. Advertisement of the AP PUO constraints

In this disclosure, a number of solutions are presented for handling the broadcast/restricted TWT schedule of the non-AP MLD when the non-AP MLD roams from a current AP MLD to a target AP MLD, including:
1 Setup a new one and provide information to the non-AP MLD
2. Inform the non-AP MLD that a similar one exists or can be setup and provide information
3. Obtain membership for the non-AP MLD and inform the non-AP MLD
4. Inform the non-AP MLD about the existence of a schedule that meets its needs
5. Example signaling

In this disclosure, a number of solutions are presented for handling DPS operation parameters and behavior during seamless roaming procedures, including:
1. Target AP enables DPS mode
2. Current AP enables DPS mode Current AP enables DPS mode
3. STA enables DPS mode
4. DPS capability information handling

### A. Periodic Unavailability Handling Under Seamless Roaming

1. Indication of Frequency Resources on which the STA can be Unavailable

FIG. 8 illustrates an example of providing frequency resource unavailability information at the time of setting up P2P TWT 800 according to embodiments of the present disclosure. The embodiment of providing frequency resource unavailability information at the time of setting up P2P TWT shown in FIG. 8 is for illustration only. Other embodiments of providing frequency resource unavailability information at the time of setting up P2P TWT could be used without departing from the scope of this disclosure.

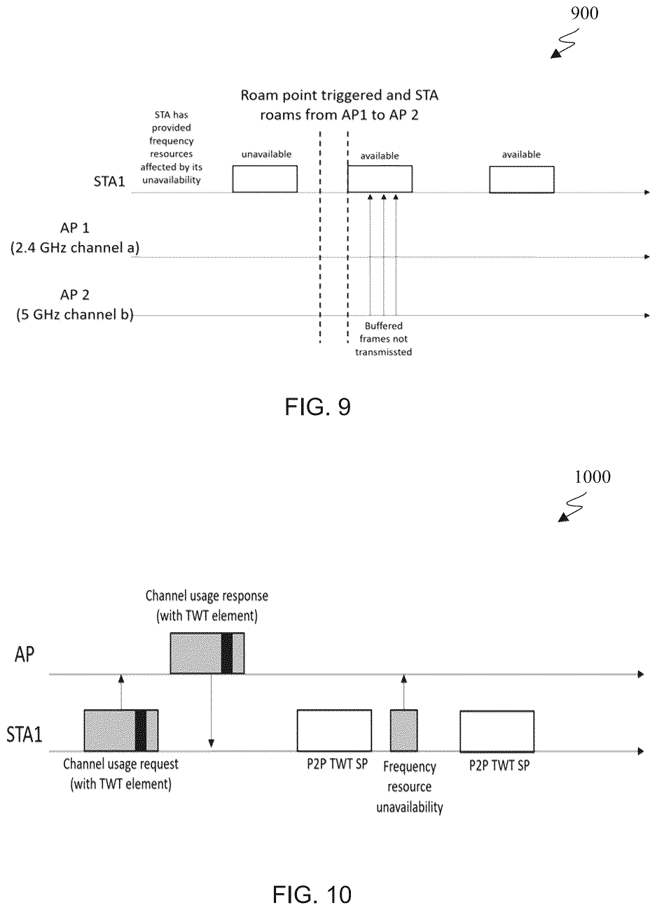

FIG. 9 illustrates an example of providing a frequency resource based P2P unavailability indication 900 according to embodiments of the present disclosure. The embodiment of providing a frequency resource based P2P unavailability indication 900 shown in FIG. 9 is for illustration only. Other embodiments of providing a frequency resource based P2P unavailability indication could be used without departing from the scope of this disclosure.

According to one embodiment, the STA can inform the AP about the frequency resources (e.g., band information, channel information, bandwidth, resource units, etc.) on which it can be unavailable.

According to one embodiment, the STA can provide this information at the time of setting up the P2P TWT agreement as shown in FIG. 8 and the example in FIG. 9.

The P2P TWT SP is setup if unavailability applies to the AP's frequency resources. When a STA transitions from the current AP to the target AP, the current AP can inform the target AP about the periodic unavailability and if the unavailability applies to the target AP's frequency resources, then the target AP can treat the STA as unavailable or else the STA can continue to be treated as available.

FIG. 10 illustrates an example of providing frequency resource unavailability information after setting up P2P TWT 1000 according to embodiments of the present disclosure. The embodiment of providing frequency resource unavailability information after setting up P2P TWT 1000 shown in FIG. 10 is for illustration only. Other embodiments of providing frequency resource unavailability information after setting up P2P TWT could be used without departing from the scope of this disclosure.

According to another embodiment, the STA can provide this information after setting up a P2P TWT agreement as shown in FIG. 10.

The frequency resources affected by unavailability can be indicated using a new frame/element/field/subfield or by modifying any of the existing frames/elements/fields/subfields in the specification.

### 2. Transfer of Periodic Unavailability Session

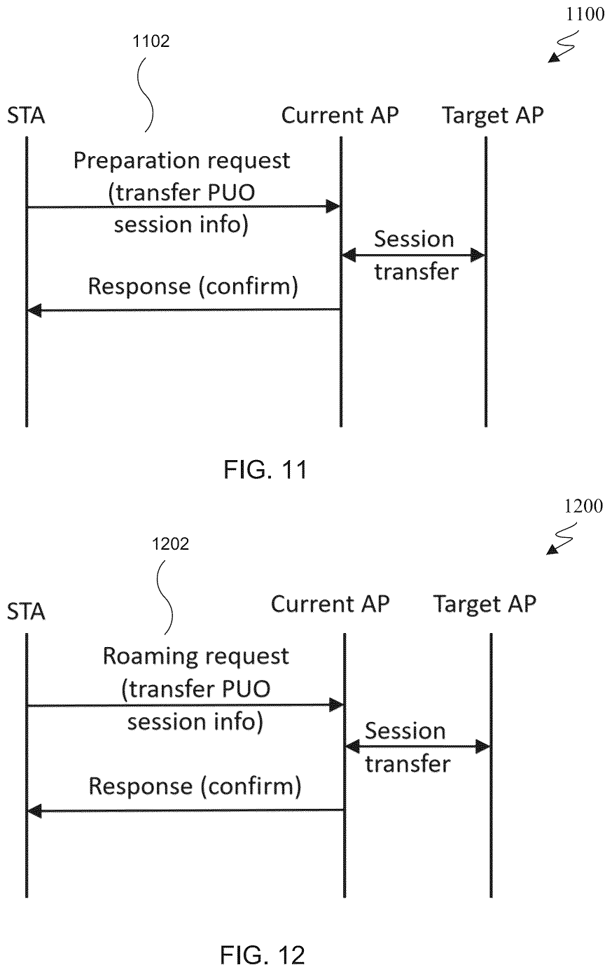

FIG. 11 illustrates an example call flow 1100 for transfer of PUO information during the preparation phase according to embodiments of the present disclosure. The example call flow 1100 for transfer of PUO information during the preparation phase shown in FIG. 11 is for illustration only. Other embodiments of an example call flow for transfer of periodic unavailability operation (PUO) information during the preparation phase could be used without departing from the scope of this disclosure.

FIG. 12 illustrates an example call flow 1200 for transfer of PUO information during roaming according to embodiments of the present disclosure. The example call flow 1200 for transfer of PUO information during the roaming phase shown in FIG. 12 is for illustration only. Other embodiments of an example call flow for transfer of PUO information during the roaming phase could be used without departing from the scope of this disclosure.

According to one embodiment, the periodic unavailability session can be transferred from the current AP to the target AP.

The STA can indicate if the STA intends to transfer the session from the current AP to the target AP. This can help to address the cases wherein the corresponding information does not apply to the target AP or does apply to the target AP.

The STA can indicate in the preparation (1102) or execution (1202) phase as shown in FIG. 11 and FIG. 12. The indication can be provided in a modified link reconfiguration request frame transmitted to the current AP or target AP. The indication can be in the form of a field (e.g., a bit) that can take a predetermined value (e.g., 1) to make the indication and another predetermined value (e.g., 0) to indicate otherwise.

The modified link reconfiguration request frame can request for a transfer of the periodic unavailability context from the current AP to the target AP. The current AP can convert the parameters from its own TSF timer to the target AP's TSF timer so that the target AP can understand the parameters of the periodic unavailability.

### 3. Transfer of the Next Unavailability SP Information

According to one embodiment, only the next P2P TWT service period can be transferred to the target AP. The non-AP STA can setup the P2P TWT again with the target AP if necessary, upon roam.

### 4. Cancellation of PUO at the Current AP/Target AP

According to one embodiment, the PUO session can be cancelled at the current AP or the target AP upon roam by the non-AP STA. The non-AP STA can then reset up the PUO session at the target AP if applicable.

According to this embodiment, the non-AP MLD can discover if the APs affiliated with target AP MLD support PUO mode of operation via the current AP MLD. The discovery can be performed by transmitting a BTM query frame to the current AP MLD and receiving a BTM request frame from the current AP MLD. In the BTM request frame, the current AP MLD can include a capabilities element that can indicate if the target AP MLD can support PUO mode or not. The current AP MLD can also provide an unsolicited BTM request frame to the non-AP MLD and inform about the PUO mode support on the APs of the target AP MLD.

The non-AP MLD can also acquire this information from other methods of discovery mentioned herein.

If one or more APs at the target AP MLD do not support the PUO mode of operation and the APs not supporting the PUO mode of operation are the APs that the non-AP MLD added links with at the target AP MLD as a part of the preparation procedure, the non-AP MLD can tear down its PUO mode at the current AP MLD prior to performing the execution procedure.

If one or more APs at the target AP MLD do not support the PUO mode of operation and the APs not supporting the PUO mode of operation are the APs that the non-AP MLD added links with at the target AP MLD as a part of the preparation procedure, the non-AP MLD can transition to the target AP MLD and not setup the PUO mode at the target AP MLD for those APs i.e., transition to the target AP MLD with the understanding that the PUO cannot be setup at the target AP MLD for those APs.

If one or more APs at the target AP MLD support the PUO mode of operation and the APs supporting the PUO mode of operation are the APs that the non-AP MLD added links with at the target AP MLD as a part of the preparation procedure, the non-AP MLD can transition to the target AP MLD and setup PUO mode of operation with the prepared APs i.e., transition to the target AP MLD with the understanding that the PUO can be setup at the target AP MLD for those APs.

### 5. Setup a PUO Session at the Target AP Via the Current AP

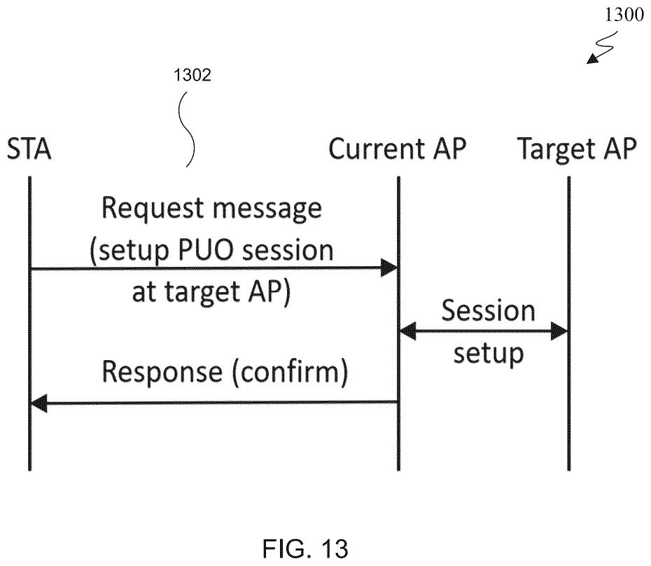

FIG. 13 illustrates an example call flow 1300 for PUO session setup at the target AP via the current AP according to embodiments of the present disclosure. The example call flow 1300 for PUO session setup at the target AP via the current AP shown in FIG. 13 is for illustration only. Other embodiments of an example call flow for PUO session setup at the target AP via the current AP could be used without departing from the scope of this disclosure.

According to one embodiment as illustrated in FIG. 13, the STA can setup a PUO session for future unavailability at the target AP. The STA can setup the PUO session by transmitting a request message (1302) to the current AP MLD.

### 6. Capability Indication

According to one embodiment, an AP MLD that supports the frequency resource unavailability indication message or any of the procedures indicated in this disclosure can advertise its capability to do so in one or more frames that it can transmit. For example, management frames such as beacons, probe responses, etc. The indication can be in the form of a field (e.g., a bit) that can take a predetermined value (e.g., 1) to make the indication and to another predetermined value (e.g., 0) to indicate otherwise.

A non-AP MLD that supports the frequency resource unavailability indication message or any of the procedures indicated in this disclosure can advertise its capability to do so in one or more frames that it can transmit. For example, management frames such as probe requests, (Re) association requests, etc. The indication can be in the form of a field (e.g., a bit) that can take a predetermined value (e.g., 1) to make the indication and to another predetermined value (e.g., 0) to indicate otherwise.

### 7. Target AP MLD's AP Becomes Available

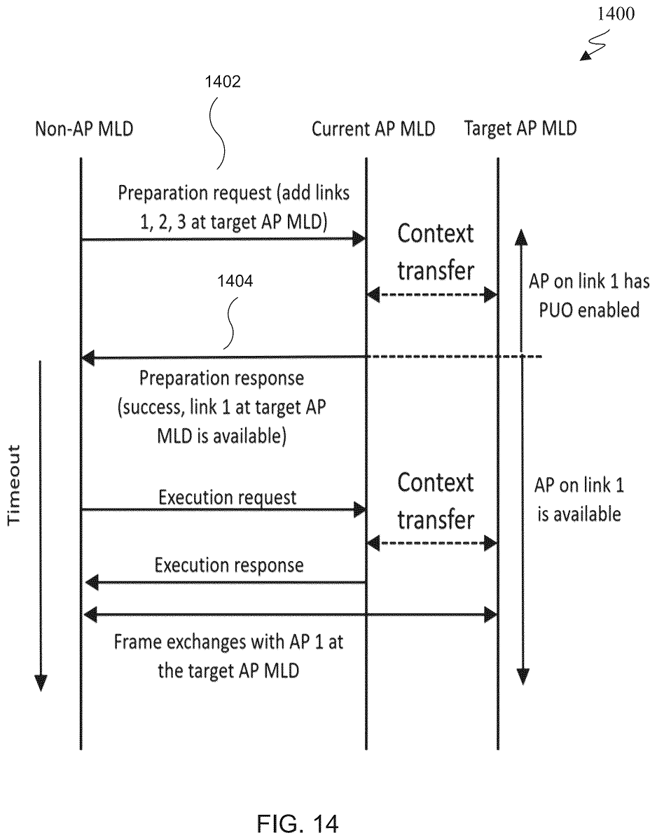

FIG. 14 illustrates an example call flow 1400 showing target AP MLD AP PUO handling according to embodiments of the present disclosure. The example call flow 1400 showing target AP MLD AP PUO handling shown in FIG. 14 is for illustration only. Other embodiments of an example call flow showing target AP MLD AP PUO handling could be used without departing from the scope of this disclosure.

As shown in FIG. 14, according to one embodiment, upon receiving a preparation request frame (1402) from a non-AP MLD, the current AP MLD can communicate with the target AP MLD. This communication can occur over the wired network (e.g., as in enterprise scenario) or over the air (e.g., as in easy mesh system). If the APs at the target AP MLD with whom a link is being added as a part of the preparation are under AP PUO mode of operation and have TWT schedules to indicate periodic unavailability and if the links are successfully added, then at least one of the APs with whom a link has been successfully added can become available (e.g., disable PUO) for the timeout period that is advertised (e.g., in the SMD information element). After timeout period, they can again enable the periodic unavailability. According to one embodiment, becoming available can mean disabling the PUO. According to another embodiment, becoming available can mean suspending the PUO temporarily.

The target AP MLD can communicate this information to the current AP MLD. The current AP MLD can transmit a preparation response frame (1404) to the non-AP MLD indicating the APs with whom a link has been successfully added and the AP(s) that can become available. Based on this understanding, the non-AP MLD can communicate with the APs that are available when it transitions to the target AP MLD first.

When the one or more APs at the target AP MLD become available, becoming available can mean becoming available for the non-AP STAs affiliated with the non-AP MLD and announcing the availability (e.g., via enhanced BSS parameter critical update) to its currently associated STAs as soon as possible in implementation.

It can also mean first announcing to its associated STAs i.e., to perform the enhanced BSS parameter critical update and then communicate with the current AP MLD.

According to one embodiment, the one or more APs at the target AP MLD can become available regardless of the AP PUO support at the non-AP STAs affiliated with the non-AP MLD.

According to another embodiment, the one or more APs at the target AP MLD can become available for the non-AP STAs affiliated with the non-AP MLD which are not AP PUO assisting non-AP STAs.

According to another embodiment, the one or more APs at the target AP MLD can become available if none of the non-AP STAs affiliated with the non-AP MLD are AP PUO assisting non-AP STAs.

In the UHR link reconfiguration response frame transmitted by the current AP MLD to the non-AP MLD, the reconfiguration multi-link element can indicate for at least one of the accepted links that the AP PUO mode for the corresponding AP can be disabled for the timeout period. The AP PUO mode can also remain disabled for a predetermined/pre-known period of time in addition to the timeout period.

If a non-AP STA affiliated with the non-AP MLD is not an AP PUO assisting STA, then upon transition, the corresponding AP at the target AP MLD can disable AP PUO for the link even after non-AP MLD transitions to the target AP MLD. This can be done to ensure that the non-AP STA that is not an AP PUO assisting STA can communicate with the AP affiliated with the target AP MLD and does not face any conflicts.

If non-AP STA affiliated with the non-AP MLD is an AP PUO assisting STA, then upon transition, the corresponding AP at the target AP MLD can enable AP PUO if needed for the link after non-AP MLD transitions to the target AP MLD. This can be done because the non-AP STA won't face any conflicts with the AP PUO mode of operation at the target AP MLD.

### 8. Advertisement of the AP PUO Constraints

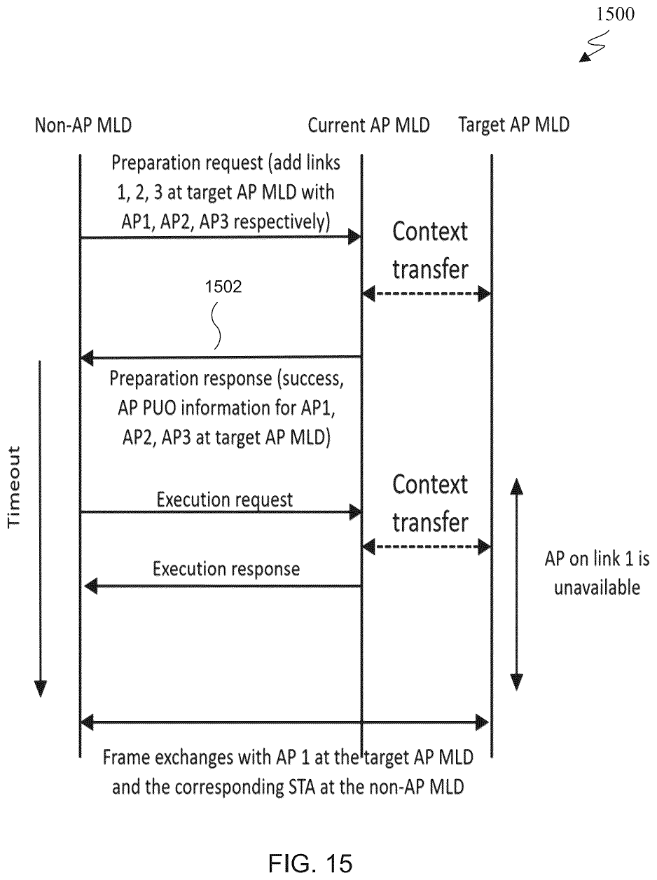

FIG. 15 illustrates an example call flow 1500 showing advertisement of AP PUO constraints according to embodiments of the present disclosure. The example call flow 1500 showing advertisement of AP PUO constraints shown in FIG. 15 is for illustration only. Other embodiments of an example call flow showing advertisement of AP PUO constraints could be used without departing from the scope of this disclosure.

As shown in FIG. 15, according to one embodiment, in the preparation response frame (1502) or the BTM request frame transmitted to the non-AP MLD by the current AP MLD, the non-AP MLD can be provided with information about the AP PUO parameters at the target AP MLD. The information can comprise the TWT schedule information corresponding to the periodic unavailability of the APs affiliated with the target AP MLD. When the TWT schedule information is provided, the parameters of the TWT schedule that are indicated in terms of the TSF time (e.g., TWT SP start time) can be provided in terms of the TSF of the link on which the frame carrying the parameters is transmitted. For example, if the information is transmitted in a BTM query transmitted on a first link setup between the current AP MLD and the non-AP MLD, the parameters can be indicated in terms of the TSF of the first link.

Thus, in the UHR link reconfiguration response frame that acts as a preparation response frame, there can be information (e.g., TWT elements) that can indicate the periodic unavailability of the target AP MLD. When a non-AP MLD receives the information, the corresponding non-AP STAs can initiate frame exchanges with the corresponding APs of the target AP MLDs in accordance with their periodic unavailability schedules i.e., during the time periods when those APs are available.

### B. Broadcast and Restricted TWT Handling Under Seamless Roaming

### 1. Setup a New One and Provide Information to the Non-AP MLD

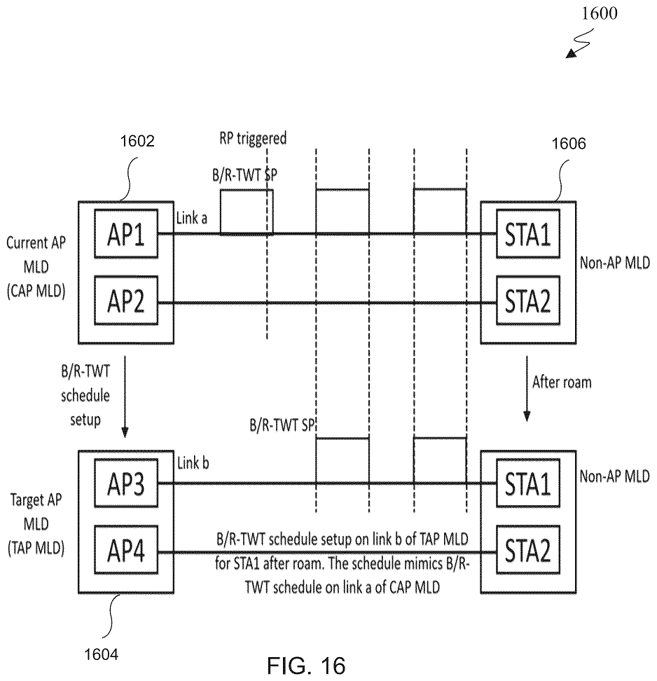

FIG. 16 illustrates an example schedule from the current AP MLD setup at the target AP MLD 1600 according to embodiments of the present disclosure. The example schedule from the current AP MLD setup at the target AP MLD 1600 shown in FIG. 16 is for illustration only. Other embodiments of the example schedule from the current AP MLD setup at the target AP MLD could be used without departing from the scope of this disclosure.

According to one embodiment, the current AP MLD (1602) can setup a new broadcast/restricted TWT schedule at the target AP MLD (1604) that meets the requirements of the non-AP MLD.

The current AP MLD (1602) can inform the non-AP MLD (1606) about the setup and provide the parameters corresponding to the setup.

The non-AP MLD (1606) can transmit a request message to the current AP MLD (1602) to request the current AP MLD (1602) to setup a broadcast/restricted TWT schedule at the target AP MLD (1604) that can meet its requirements.

The message can contain at least one or more of the information items as depicted in Table 1.

TABLE 1
Information items in the request message

| Information item | Description |
|---|---|
| Setup request indication | One or more information items that can provide a setup request |
| | indication. This can inform the current AP MLD that a |
| | broadcast/restricted TWT schedule needs to be setup at the target |
| | AP MLD for the non-AP MLD. This indication can also be |
| | provided implicitly by using a frame whose frame type conveys a |
| | request indication. |
| Broadcast/restricted | One or more information items that can provide an indication of |
| TWT schedule indicator | a broadcast/restricted TWT schedule that the STA affiliated with |
| | the non-AP MLD is a member of at the current AP MLD and |
| | prefers to have a same or similar broadcast/restricted TWT |
| | schedule setup at the target AP MLD. For example, broadcast |
| | TWT ID. |
| Current AP MLD link | One or more information items that can provide an indication of |
| indicator | the current AP MLD's link on which the broadcast/restricted |
| | TWT schedule referred to by the above information item is setup |
| | of. For example, link ID. |
| Target AP MLD link | One or more information items that can provide an indication of |
| indicator | the target AP MLD's link on which the broadcast/restricted TWT |
| | schedule is preferred to be setup on. For example, link ID of the |
| | target AP MLD. |
| Broadcast/restricted | One or more information items that can provide an indication of |
| TWT schedule | |
| parameters | what type of broadcast/restricted TWT schedule the non-AP |
| | MLD prefers to have setup at the target AP MLD. For example, |
| | TWT wake time, Nominal Minimum TWT Wake Duration, TWT |
| | Wake Interval Mantissa, one or more information items present |
| | in a TWT element, etc. |

Upon receiving the above request message, the current AP MLD (1602) can communicate with the target AP MLD (1604) and setup a broadcast TWT schedule for the non-AP MLD (1606). The current AP MLD can transmit a response message to the non-AP MLD (1606). The response message can contain at least one or more of the information items as indicated in Table 2.

TABLE 2
Information items that can be present in the response message

| Information item | Description |
|---|---|
| Setup indication | One or more information items that can indicate that the |
| | broadcast/restricted TWT schedule has been setup at the target AP |
| | MLD. For example, a success/failure indication. |
| Broadcast/restricted | One or more information items that can indicate the parameters of |
| TWT parameters | the broadcast/restricted TWT schedule at the target AP MLD. For |
| | example, a TWT element containing the broadcast/restricted TWT |
| | parameter set or one or more of the information items present in a |
| | TWT element to characterize a broadcast/restricted TWT schedule at |
| | the target AP MLD. The timing information in these elements can |
| | either be provided relative to the current AP's TSF timer so that the |
| | STA can understand the information or can be provided relative to |
| | the target AP MLD's TSF timer. |
| Broadcast/restricted | One or more information items that can indicate the |
| TWT indicators | broadcast/restricted TWT schedule at the target AP MLD. For |
| | example, a broadcast TWT ID. |
| Link indicator at | One or more information items that can indicate the link of the |
| current AP MLD | current AP MLD the broadcast/restricted TWT schedule |
| | corresponding to which is mimicked at the target AP MLD's link. |
| Link indicator at the | One or more information items that can indicate the link of the target |
| target AP MLD | AP MLD where the above referenced broadcast/restricted TWT |
| | schedule has been setup on. |

Upon receiving the above information, the STA of a non-AP MLD can understand the broadcast/restricted TWT schedule at the target AP MLD that it can participate in after roaming.

The above response can also be transmitted in an unsolicited manner to the non-AP MLD by the current AP MLD at the time of roam.

2. Inform the Non-AP MLD that a Similar One Exists or can be Setup and Provide Information

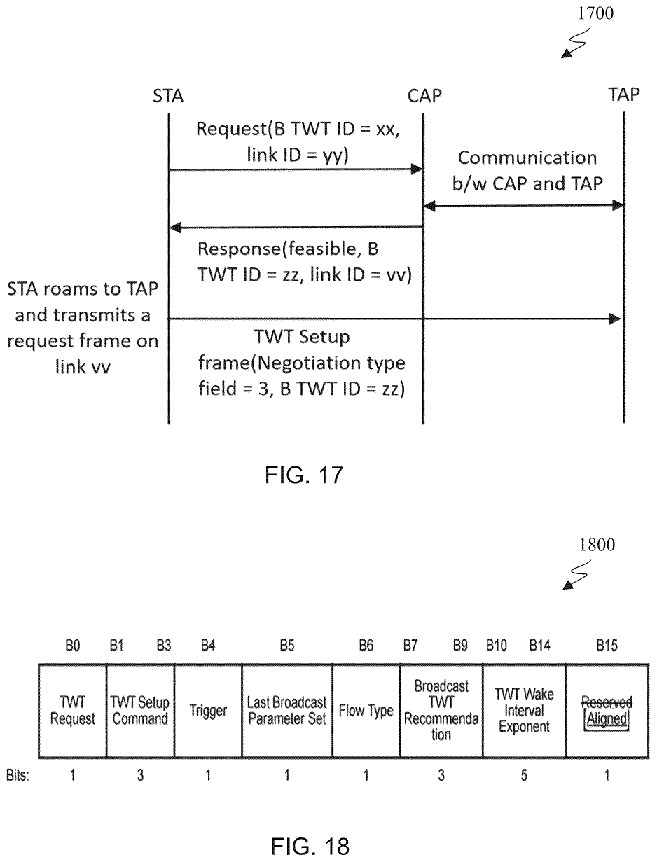

FIG. 17 illustrates an example call flow 1700 showing information about similar broadcast TWT existence at the target AP according to embodiments of the present disclosure. The example call flow 1700 showing information about similar broadcast TWT existence at the target AP shown in FIG. 17 is for illustration only. Other embodiments of the example call flow showing information about similar broadcast TWT existence at the target AP could be used without departing from the scope of this disclosure.

According to one embodiment, the current AP MLD can inform the non-AP MLD that a B/R-TWT schedule similar to the one that its affiliated STA is a member of exists or can be setup at the target AP and provide information about the schedule to the non-AP MLD.

The non-AP MLD can request such information from the current AP MLD by transmitting a request message to the current AP MLD. The request message can contain at least one or more of the information items as indicated in Table 3.

TABLE 3
Information items that can be present in the request message

| Information item | Description |
|---|---|
| B/R-TWT setup/joining | One or more information items that can indicate a request from |
| feasibility check request | the non-AP MLD to the current AP MLD to perform a the B/R- |
| | TWT setup/joining feasibility check with the target AP MLD. |
| B/R-TWT indicator | One or more information items that can indicate the B/R-TWT |
| | schedule at the current AP MLD that the non-AP MLD prefers to |
| | have setup or join a same/similar one already existing at the |
| | target AP MLD. For example, Broadcast TWT ID, one or more |
| | information items present in a TWT element, etc. |
| Link indicator | One or more information items that can indicate the link on |
| | which the B/R-TWT schedule referred to above has been setup |
| | on. For example, Link ID. |

Upon receiving the above message, the current AP MLD can check with the target AP MLD and inform the non-AP MLD about the setup/joining feasibility check.

The current AP MLD can transmit a response message to the non-AP MLD to inform the non-AP MLD about the feasibility check result. The response frame can contain at least one or more of the information items as indicated in Table 4.

TABLE 4
Information items that can be present in the response message

| Information item | Description |
|---|---|
| B/R-TWT setup/joining | One or more information items that can indicate a response for |
| feasibility check | the request made by the non-AP MLD. For example, |
| response | success/failure indication or feasible/infeasible indication. |
| B/R-TWT indicator | One or more information items that can indicate the B/R-TWT |
| | schedule at the target AP MLD that is similar to the B/R-TWT |
| | schedule that the non-AP MLD indicated in the request frame. |
| | For example, Broadcast TWT ID. |
| B/R-TWT parameter | One or more information items that can characterize the B/R- |
| indicator | TWT parameters for the B/R-TWT schedule indicated above. |
| | For example, target wake time, nominal minimum TWT wake |
| | duration, TWT wake interval mantissa, one or more information |
| | items present in a TWT element etc. The target wake time can |
| | be relative to the TSF timer of the current AP. In another |
| | embodiment, it can also be relative to the TSF timer of the |
| | target AP. |
| Link indicator | One or more information items that can indicate the link on |
| | which the B/R-TWT schedule referred to above exists or can be |
| | setup. For example, link ID. |

### 3. Obtain Membership for the Non-AP MLD and Inform the Non-AP MLD

According to one embodiment, the current AP MLD can also obtain a membership for the B/R-TWT schedule indicated in the previous section for the non-AP MLD. A STA affiliated with the non-AP MLD can be provided with a deadline to join the B/R-TWT schedule. If the non-AP MLD does not roam to the target AP MLD in time, the membership can be cancelled.

4. Inform the Non-AP MLD about the Existence of a Schedule that Meets its Needs

According to one embodiment, the current AP MLD can inform a non-AP MLD (unsolicited or upon request) about the existence of a B/R-TWT schedule at the target AP MLD that meets the requirements of the non-AP MLD or is similar or same as its current B/R-TWT schedule.

According to another embodiment, the current AP MLD can also inform the non-AP MLD about which B/R-TWT schedules at the current AP MLD have similar or same B/R-TWT schedules at the target AP MLD.

According to another embodiment, the current AP MLD can inform the non-AP MLD about the AP MLDs in the UHR seamless roaming domain that have the same/similar schedules as its current B/R-TWT schedule at the current AP MLD. This information can help the non-AP MLD in target AP MLD selection.

According to one embodiment, the non-AP MLD can transmit a request message to request the above information. The current AP MLD can assess which target AP MLD have the same or similar schedules as the B/R-TWT schedule at the current AP MLD and provide the information to the non-AP MLD in a response message. The response message can contain at least one or more of the information items as indicated in Table 5.

TABLE 5
Information items that can provide the indication of the existence of the schedule

| Information item | Description |
|---|---|
| B/R-TWT schedule | One or more information items that can indicate the B/R-TWT |
| indicator | schedule. For example, Broadcast TWT ID, one or more information |
| | items present in a TWT element, etc. |
| Current AP MLD | One or more information items that can indicate the link at the current |
| link indicator | AP MLD at which the above indicated B/R-TWT schedule exists. For |
| | example, link ID. |
| Target AP MLD | One or more information items that can indicate the link at the target |
| link indicator | AP MLD at which a similar or same B/R-TWT schedule exists. For |
| | example, link ID |
| B/R-TWT schedule | One or more information items that can indicate the B/R-TWT |
| indicator | schedule indicator at the target AP MLD. For example, Broadcast |
| | TWT ID, one or more information items present in a TWT element, |
| | etc. |

According to one embodiment, for B/R-TWT schedules at the current AP MLD, the current AP MLD can provide information on whether the B/R-TWT schedules exist at (e.g., at least at one or more) AP MLD in the same UHR seamless roaming domain as the current AP MLD. This information can enable the non-AP MLD to increase its chances of successfully finding a similar/same B/R-TWT schedule at another AP MLD in the same UHR seamless roaming domain upon roaming.

### 5. Example Signaling

FIG. 18 illustrates an example request type field format 1800 according to embodiments of the present disclosure. The example request type field format 1800 shown in FIG. 18 is for illustration only. Other embodiments of the example request type field format could be used without departing from the scope of this disclosure.

A TWT element can be included in the roam/preparation response frame as shown in FIG. 18 where a modified link reconfiguration response frame is used as a roam/preparation response frame. The TWT element can have a broadcast TWT parameter set field which can have an aligned bit set to 1 to indicate there can be a schedule on the link(s) of the target AP MLD in the same UHR seamless roaming domain as the current AP MLD that is aligned or aligned within a certain TU interval with the schedule identified by the broadcast TWT parameter set field. If set to 0, it indicate that there is no such schedule on link(s) of the target AP MLD. The response frame can contain at least one or more of the information items as indicated in Table 6.

TABLE 6
Example link reconfiguration response frame action field format.
Order can be different and extra information items can be present.

| Order | Meaning |
|---|---|
| 1 | Category |
| 2 | Protected EHT/UHR Action |
| 3 | Dialog Token |
| 4 | Count |
| 5 | Reconfiguration Status List |
| 6 | Group Key Data (optional) |
| 7 | OCI element (optional) |
| 8 | Basic Multi-link element |
| | (optional) |
| 9 | TWT element |

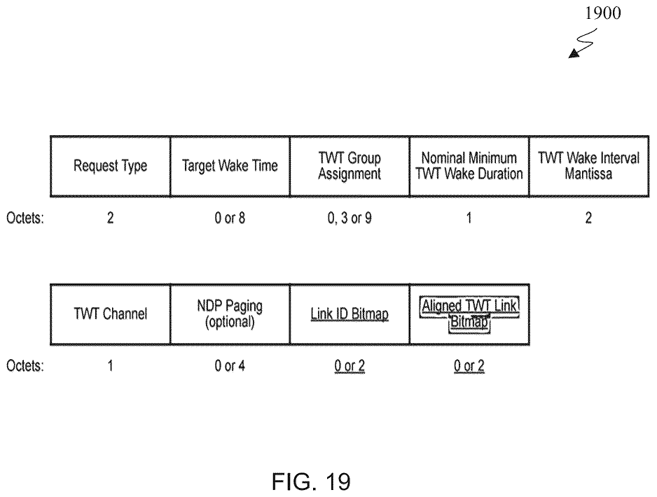

FIG. 19 illustrates an example TWT parameter set field format 1900 according to embodiments of the present disclosure. The example TWT parameter set field format 1900 shown in FIG. 19 is for illustration only. Other embodiments of the example TWT parameter set field format could be used without departing from the scope of this disclosure.

As shown in FIG. 19, there can be an aligned TWT link bitmap which can indicate the links of the target AP MLD that can have aligned TWT SPs with the schedule indicated by the broadcast TWT ID/link indicated by the link ID bitmap. A value of 1 in the bit position i of the aligned TWT link bitmap subfield means the link associated with the link ID i of the target AP MLD has the aligned TWT SPs with the link indicated by the link ID bitmap/schedule indicated by the broadcast TWT ID. A value of 0 in the bit position i of the aligned TWT link bitmap subfield means that the link associated with the link ID i is the link that does not have the aligned TWT SPs with the link indicated by the link ID bitmap/schedule indicated by the broadcast TWT ID. The link ID bitmap can indicate the links at the current AP MLD and the aligned TWT link bitmap can indicate the link at the target AP. Likewise, the broadcast TWT ID can indicate the broadcast TWT ID at the current AP MLD.

Same B/R-TWT schedules can also mean aligned schedules i.e., two B/R-TWT schedules can be same if they are aligned with each other.

To request the TWT, there can be a bit in a modified link reconfiguration request frame which can be set to a value of 1 to indicate that the non-AP MLD wants to request information on aligned TWT on the links of the target AP MLD. When the current AP MLD receives the modified link reconfiguration request frame, the current AP MLD can generate and transmit the above described modified link reconfiguration response frame.

Similar B/R-TWT schedules can also mean schedules that are aligned with a certain time margin (e.g., expressed in terms of TU) i.e., two B/R-TWT schedules can be similar if they are aligned within a certain TU interval of each other.

According to another embodiment, a B/R-TWT schedule at the target AP MLD can be considered as similar to a B/R-TWT schedule at the current AP MLD if it can meet the requirements (e.g., latency) of the traffic of the non-AP MLD as being met by the B/R-TWT schedule at the current AP MLD. The above signaling can also be used to indicate such similar B/R-TWT schedules instead of indicating aligned schedules.

The current AP and target AP MLDs can be a part of a UHR seamless roaming domain.

### C. DYNAMIC POWER SAVE HANDLING UNDER SEAMLESS ROAMING

### 1. Target AP Enables DPS Mode:

When the target AP goes into DPS mode, it can inform the STA about the DPS mode enablement. If the STA is still with the current AP, the target AP can inform the STA via the current AP.

The target AP's DPS mode enablement information can be provided by the current AP to the STA at the time of discovery/enhanced discovery. The information can be included in a BTM frame. For example, a BTM request frame. This can be done by including a field (e.g., a bit) that takes a predetermined value (e.g., 1) to make the indication for enablement and another predetermined value (e.g., 0) to make the indication for disablement.

The target AP's DPS mode enablement information can be provided by the current AP to the STA at the time of preparation. The information can be included in a modified link reconfiguration response frame. This can be done by including a field (e.g., a bit) that takes a predetermined value (e.g., 1) to make the indication for enablement and another predetermined value (e.g., 0) to make the indication for disablement.

The target AP's DPS mode enablement information can be provided by the current AP to the STA at the time of roam execution/transition. The information can be included in a modified link reconfiguration response frame. This can be done by including a field (e.g., a bit) that takes a predetermined value (e.g., 1) to make the indication for enablement and another predetermined value (e.g., 0) to make the indication for disablement.

When a STA finds out about the target AP's DPS mode enablement, the STA can then initiate transmissions with the target AP using an ICF frame upon roaming.

According to one embodiment, when a STA performs roam execution phase, the target AP can disable DPS mode or refrain from going into DPS mode and enable it (again if disabled) after the STA transitions to the target AP. According to another embodiment, the DPS mode can be enabled at the target AP after the STA transitions to the target AP and brings the prepared link state out of a (default) power save mode.

According to one embodiment, when a DS remapping is initiated, the target AP can disable DPS mode or refrain from enabling DPS mode.

According to one embodiment, when a STA does not support DPS mode and roams to a target AP that does, the target AP can disable its DPS mode.

### 2. Current AP Enables DPS Mode:

According to one embodiment, when the current AP goes into DPS mode, it can inform the STA about it. If the STA has completed roam execution phase with the target AP and its links are still active at the current AP, the current AP can inform to the STA when communicating with it or can inform the STA via the target AP if the STA is communicating with the target AP at the time of informing the STA. The target AP can provide the STA with the information about the current AP's DPS mode.

According to one embodiment, if the current AP goes into or intends to go into DPS mode at the time of roam execution phase, it can inform the STA as a part of the roam execution response frame. The information can be included in a modified link reconfiguration response frame. This can be done by including a field (e.g., a bit) that takes a predetermined value (e.g., 1) to make the indication for enablement and another predetermined value (e.g., 0) to make the indication for disablement.

The STA can also find out about the current AP's DPS mode enablement from the target AP via an enhanced discovery

When a STA finds out about the current AP's DPS mode enablement, the STA can then initiate transmissions with the current AP using an ICF frame. For example, when fetching buffered frames at the current AP. The information can be included in a BTM frame. For example, a BTM request frame. This can be done by including a field (e.g., a bit) that takes a predetermined value (e.g., 1) to make the indication for enablement and another predetermined value (e.g., 0) to make the indication for disablement.

According to one embodiment, the current AP can refrain from going into DPS mode when at least one of its STA is fetching buffered frames post roaming.

According to one embodiment, the current AP can refrain from going into DPS mode when at least one of its STAs that does not support DPS mode is fetching buffered frames post roaming.

### 1. STA Enables DPS Mode:

When a STA goes into or is in DPS mode at the time of roaming, the current AP can inform the target AP about the STA's DPS mode enablement. This can enable the target AP to initiate communications with the STA using an ICF.

The current AP can inform the target AP at the time of preparation phase.

The current AP can inform the target AP at the time of execution/transition phase.

According to one embodiment, the STA cannot keep DPS mode enabled when it is in the process of roaming from current AP to a target AP.

According to one embodiment, when the STA receives a roam execution response frame from the current AP, it can disable its DPS mode until it has fully transitioned to the target AP.

### 2. DPS Capability Information Handling:

The DPS capability of an AP in a UHR seamless roaming domain can be provided to the STA as a part of discovery or enhanced discovery procedure where the STA gathers information about the roaming candidates. According to one embodiment, the information can be provided by the current AP of the STA.

The DPS capability of an AP in a UHR seamless roaming domain can be provided to the STA as a part of a preparation procedure. The link reconfiguration response frame can carry a multi-link element that can indicate the DPS capability of the target AP.

The DPS capability of an AP in a UHR seamless roaming domain can be provided to the STA as a part of a roaming execution procedure. The link reconfiguration response frame can carry a multi-link element that can indicate the DPS capability of the target AP. The information can also be present in a separate field in the link reconfiguration response frame.

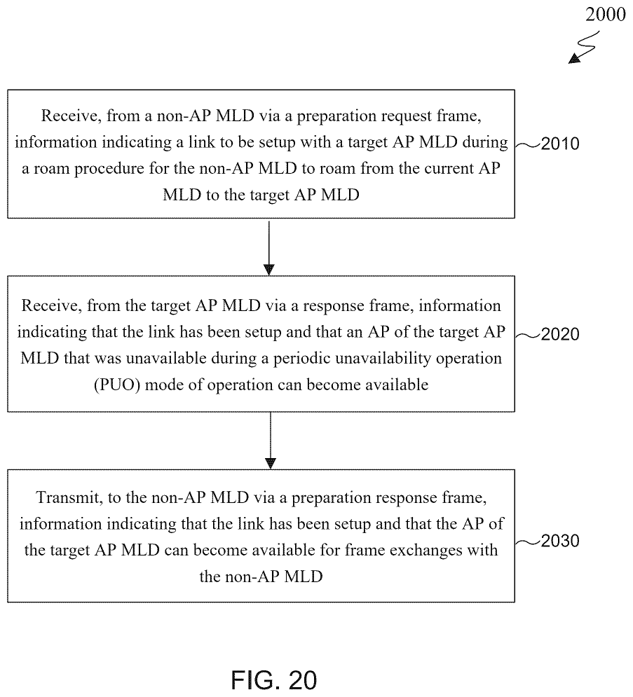

FIG. 20 illustrates an example method 2000 performed by a current access point (AP) multi-link device (MLD) in a wireless communication system according to embodiments of the present disclosure. The method 2000 of FIG. 20 can be performed by any of the APs 101-103 of FIG. 1, such as AP 101 of FIG. 2A, and a corresponding method can be performed by any of the STAs 111-114 of FIG. 1, such as the STA 111 of FIG. 2B. The method 2000 is for illustration only and other embodiments can be used without departing from the scope of the present disclosure.

As illustrated in FIG. 20, the method 2000 begins at step 2010, where the current AP MLD receives, from a non-AP MLD via a preparation request frame, information indicating a link to be setup with a target AP MLD during a roam procedure for the non-AP MLD to roam from the current AP MLD to the target AP MLD. At step 2020, the current AP MLD receives, from the target AP MLD via a response frame, information indicating that the link has been setup and that an AP of the target AP MLD that was unavailable during a periodic unavailability operation (PUO) mode of operation can become available. At step 2030, the current AP MLD transmits, to the non-AP MLD via a preparation response frame, information indicating that the link has been setup and that the AP of the target AP MLD can become available for frame exchanges with the non-AP MLD.

In some embodiments, the AP of the target AP MLD can become available for frame exchanges with the non-AP MLD for a duration of a timeout period that is indicated via an information element.

In some embodiments, the current AP MLD transmits, to the non-AP MLD via a reconfiguration response frame, information indicating that the AP of the target AP MLD can become available for frame exchanges with the non-AP MLD for a duration of a timeout period that is indicated via an information element.

In some embodiments, the AP of the target AP MLD can become available for frame exchanges with the non-AP MLD for a predetermined period of time.

In some embodiments, the preparation response frame includes information indicating a target wake time (TWT) schedule corresponding to a periodic unavailability of the AP of the target AP MLD.

In some embodiments, the preparation request frame includes information indicating an intent to transfer a periodic unavailability session from the current AP MLD to the target AP MLD.

In some embodiments, the current AP MLD: receives, from the non-AP MLD via a request message, information indicating setup of a PUO session for future unavailability at the target AP MLD; and transmits, to the non-AP MLD via a response message, information indicating acceptance or rejection of the setup of the PUO session for future unavailability at the target AP MLD.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by a current access point (AP) multi-link device (MLD), the method comprising:
receiving, from a non-AP MLD via a preparation request frame, information indicating a link to be setup with a target AP MLD during a roam procedure for the non-AP MLD to roam from the current AP MLD to the target AP MLD;
receiving, from the target AP MLD via a response frame, information indicating that the link has been setup and that an AP of the target AP MLD that was unavailable during a periodic unavailability operation (PUO) mode of operation can become available; and
transmitting, to the non-AP MLD via a preparation response frame, information indicating that the link has been setup and that the AP of the target AP MLD can become available for frame exchanges with the non-AP MLD.

2. The method of claim 1, wherein the AP of the target AP MLD can become available for frame exchanges with the non-AP MLD for a duration of a timeout period that is indicated via an information element.

3. The method of claim 1, further comprising transmitting, to the non-AP MLD via a reconfiguration response frame, information indicating that the AP of the target AP MLD can become available for frame exchanges with the non-AP MLD for a duration of a timeout period that is indicated via an information element.

4. The method of claim 1, wherein the AP of the target AP MLD can become available for frame exchanges with the non-AP MLD for a predetermined period of time.

5. The method of claim 1, wherein the preparation response frame includes information indicating a target wake time (TWT) schedule corresponding to a periodic unavailability of the AP of the target AP MLD.

6. The method of claim 1, wherein the preparation request frame includes information indicating an intent to transfer a periodic unavailability session from the current AP MLD to the target AP MLD.

7. The method of claim 1, further comprising:
receiving, from the non-AP MLD via a request message, information indicating setup of a PUO session for future unavailability at the target AP MLD; and
transmitting, to the non-AP MLD via a response message, information indicating acceptance or rejection of the setup of the PUO session for future unavailability at the target AP MLD.

8. A method performed by a non-access point (AP) multi-link device (MLD), the method comprising:
transmitting, to a current AP MLD via a preparation request frame, information indicating a link to be setup with a target AP MLD during a roam procedure for the non-AP MLD to roam from the current AP MLD to the target AP MLD; and
receiving, from the current AP MLD via a preparation response frame, information indicating that the link has been setup and that an AP of the target AP MLD that was unavailable during a periodic unavailability operation (PUO) mode of operation can become available for frame exchanges with the non-AP MLD.

9. The method of claim 8, wherein the AP of the target AP MLD can become available for frame exchanges with the non-AP MLD for a duration of a timeout period that is indicated via an information element.

10. The method of claim 8, further comprising receiving, from the current AP MLD via a reconfiguration response frame, information indicating that the AP of the target AP MLD can become available for frame exchanges with the non-AP MLD for a duration of a timeout period that is indicated via an information element.

11. The method of claim 8, wherein the AP of the target AP MLD can become available for frame exchanges with the non-AP MLD for a predetermined period of time.

12. The method of claim 8, wherein the preparation response frame includes information indicating a target wake time (TWT) schedule corresponding to a periodic unavailability of the AP of the target AP MLD.

13. The method of claim 1, wherein the preparation request frame includes information indicating an intent to transfer a periodic unavailability session from the current AP MLD to the target AP MLD.

14. The method of claim 8, further comprising:
transmitting, to the current AP MLD via a request message, information indicating setup of a PUO session for future unavailability at the target AP MLD; and
receiving, from the current AP MLD via a response message, information indicating acceptance or rejection of the setup of the PUO session for future unavailability at the target AP MLD.

15. An electronic device comprising:
at least one processor including processing circuitry; and
memory storing instructions, wherein the instructions, when executed by the at least one processor individually or collectively, cause the electronic device to:
receive, from a non-access point (AP) multi-link device (MLD) via a preparation request frame, information indicating a link to be setup with a target AP MLD during a roam procedure for the non-AP MLD to roam from a current AP MLD to the target AP MLD;
receive, from the target AP MLD via a response frame, information indicating that the link has been setup and that an AP of the target AP MLD that was unavailable during a periodic unavailability operation (PUO) mode of operation can become available; and
transmit, to the non-AP MLD via a preparation response frame, information indicating that the link has been setup and that the AP of the target AP MLD can become available for frame exchanges with the non-AP MLD.

16. The electronic device of claim 15, wherein the AP of the target AP MLD can become available for frame exchanges with the non-AP MLD for a duration of a timeout period that is indicated via an information element.

17. The electronic device of claim 15, wherein the instructions, when executed by the at least one processor individually or collectively, cause the electronic device to transmit, to the non-AP MLD via a reconfiguration response frame, information indicating that the AP of the target AP MLD can become available for frame exchanges with the non-AP MLD for a duration of a timeout period that is indicated via an information element.

18. The electronic device of claim 15, wherein the AP of the target AP MLD can become available for frame exchanges with the non-AP MLD for a predetermined period of time.

19. The electronic device of claim 15, wherein the preparation response frame includes information indicating a target wake time (TWT) schedule corresponding to a periodic unavailability of the AP of the target AP MLD.

20. The electronic device of claim 15, wherein the preparation request frame includes information indicating an intent to transfer a periodic unavailability session from the current AP MLD to the target AP MLD.
